(19) United States
(12) Patent Application Publication
(10) Pub. No.: US 2026/0367911 A1
(43) Pub. Date: Nov. 19, 2026

(54) CITATION TOKENS FOR AUTOMATED SOFTWARE DEVELOPMENT WITH GENERATIVE RESPONSE ENGINE

(71) Applicant: OpenAI OpCo, LLC., San Francisco, CA (US)

(72) Inventors: Andrey Mishchenko, San Francisco, CA (US); Katy Shi, New York, NY (US); Shao-Qian Mah, San Francisco, CA (US); Hanson Wang, San Francisco, CA (US); Tongzhou Wang, San Francisco, CA (US); Alexander Embiricos, San Francisco, CA (US)

(73) Assignee: OpenAI OpCo, LLC., San Francisco, CA (US)

(21) Appl. No.: 19/326,386

(22) Filed: Sep. 11, 2025

Related U.S. Application Data
(60) Provisional application No. 63/806,537, filed on May 15, 2025.

(51) Int. Cl. G06F 8/77

(52) U.S. Cl. CPC G06F 8/77

(57) ABSTRACT

Systems and techniques are described herein for automating software development. For example, an apparatus is configured to: retrieve, after an agentic software development task is completed by an AI model, data generated by the AI model to complete the agentic software development task; identify a plurality of citation tokens to content within the data, wherein a respective citation token of the plurality of citation tokens includes a reference to events performed by the AI model to complete the agentic software development task; and provide a summary of actions performed during of the agentic software development task to a client device based on the data, wherein the summary includes information pertaining to changes generated based on the plurality of citation tokens.

### BACKGROUND

This application claims the benefit of priority to U.S. provisional application number 63/806,537, filed on May 15, 2025, entitled AUTOMATED SOFTWARE DEVELOPMENT WITH GENERATIVE RESPONSE ENGINE, which is expressly incorporated by reference herein in its entirety.

### BACKGROUND

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. Generative response engines can sift through vast amounts of text data, extract context, and provide coherent responses to a wide array of queries.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates an example system supporting a generative response engine during inference operations in accordance with some aspects of the disclosure.

FIG. 2 is a conceptual block diagram of an automated software development system using a generative response engine in accordance with some aspects of the disclosure.

FIG. 3 illustrates a flowchart of a process for generating citation tokens during an automated software development task in accordance with some aspects of the disclosure.

FIG. 4 illustrates a sequence diagram of an automated software development task that generates citation tokens in accordance with some aspects of the disclosure.

FIGS. 5A-5D illustrate various screens and conceptual diagrams of an automated software development system and features associated with citation tokens in accordance with some aspects of the disclosure.

FIG. 6 illustrates a flowchart of a process for generating citation tokens during an automated software development task in accordance with some aspects of the disclosure.

FIG. 7 is a block diagram illustrating an example machine-learning platform in accordance with some aspects of the disclosure.

FIG. 8A, FIG. 8B, and FIG. 8C illustrate an example transformer architecture in accordance with some aspects of the disclosure.

FIG. 9 shows an example of a system for implementing some aspects of the present technology.

### DETAILED DESCRIPTION

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation.

Many generative response engines provide a conversational user interface powered by a chatbot whereby the user account interacts with the generative response engine through natural language conversation with the chatbot. Such a user interface provides an intuitive format to provide prompts or instructions to the generative response engine. In fact, the conversational user interface powered by the chatbot can be so effective that users can feel as if they are interacting with a person. Some user accounts find the generative response engine effective enough that they utilize the conversational user interface powered by the chatbot as they would an assistant.

One use of generative response engines is automated application development and software development functions to automate complex tasks, enhance productivity, and reduce manual errors. For example, generative response engines are driven by advanced artificial (AI) models and can interpret natural language specifications or high-level requirements and generate corresponding code, documentation, or configurations, which allows developers to focus more on architectural decisions and problem-solving rather than repetitive implementation details. As an example, a function that translates user stories into unit tests or skeleton code is important because it accelerates the development phase and also enforces consistency and test coverage from the outset. A generative engine can also automate the creation and maintenance of CI/CD pipelines by writing instructions (e.g., YAML or JSON) files for workflows, and generating server deployment scripts tailored to specific cloud environments. Additionally, generative response engines can automate tasks such as database schema migrations, application programming interface (API) endpoint scaffolding, and server provisioning to streamline operations and reduce friction between development and operations teams. Generative response engines can contribute to documentation, generate performance monitoring scripts, and produce security checks. Despite these advantages, generative response engines require thorough oversight, including human review of generated code, robust automated testing, and continuous feedback loops to ensure maintainability, security, and scalability.

In systems where machine learning (ML) models generate proposed modifications to source code, maintaining human oversight throughout the workflow is used to ensure that any automated changes align with development standards, project goals, and does not have any malicious code. While the ML model can produce valid and contextually appropriate edits, these changes often include a human-in-the-loop review stage to detect subtle semantic errors, design inconsistencies, or unintended consequences that may not be captured by automated tests alone. Integrating a structured review process allows developers to validate, refine, or reject model-generated changes before they are merged, preserving code quality while leveraging the productivity benefits of automated suggestions.

Because ML models are trained using training data, prompt context, and runtime state to produce code, each modification inherently reflects assumptions, learned patterns, or prior examples that must be transparent and verifiable to stakeholders. Establishing clear logs and reports of how and why code changes were proposed supports secure and trustworthy operations and can enable teams to pinpoint the origin of any faulty or unexpected behavior. Auditable change generation mitigates operational risk and strengthens confidence in the integration of ML-driven tooling within sensitive development pipelines.

In addition, the terminal interface also plays an important role in the development process and enables developers to audit and validate actions performed by an ML system within a software development environment. Auditing the system operations by exposing each command executed, test perform, options used, and other information through the terminal allows users to retain visibility into the exact operations carried out by the ML model, rather than relying solely on abstracted outputs. Overview of command-line-driven interaction allows developers to inspect logs, verify diffs, replay or roll back actions, and cross-check the alignment of the ML system's behavior with project requirements and security policies. Such granular oversight can ensure that automated processes remain accountable and that any unintended side effects can be promptly identified and mitigated before changes are propagated to production systems.

Systems, apparatuses, processes (also referred to as “systems and techniques”) are described herein for automating software development using an AI model configured to generate and embed citation tokens within data produced during the completion of an agentic software development task. For example, the system retrieves data generated by the AI model and identifies a plurality of citation tokens that reference discrete events executed by the AI model throughout the development process. Each citation token provides traceability to specific actions, such as file modifications or terminal commands, thereby enabling a detailed summary of the task to be assembled and delivered to a client device for inspection and review.

In some aspects, a citation token is classified according to its type, such as a file citation or a command citation, based on its format and associated contextual information. For instance, a command citation may include a reference to a terminal emulator log, while a file citation may indicate a line number tied to a file change. The resulting summary may include interactable elements linked to each citation token, allowing users to navigate directly to related actions and outputs. This structured approach provides transparent insight into the agentic software development workflow and facilitates presentation of demarcated summaries and corresponding code changes within a code repository branch, ensuring comprehensive oversight of AI-generated development tasks.

To ensure accountability and correctness, the system includes a human-in-the-loop review mechanism whereby the diff and a summary of the model's proposed changes are displayed to a user. In some cases, the summary can be demarcated by interactable components (e.g., buttons) associated with the citation tokens, which allow viewing of the changes in a natural and intuitive manner. The user is able to review the changes and commands used by the automated software development system, building trust and confidence that tasks were executed similarly to a developer.

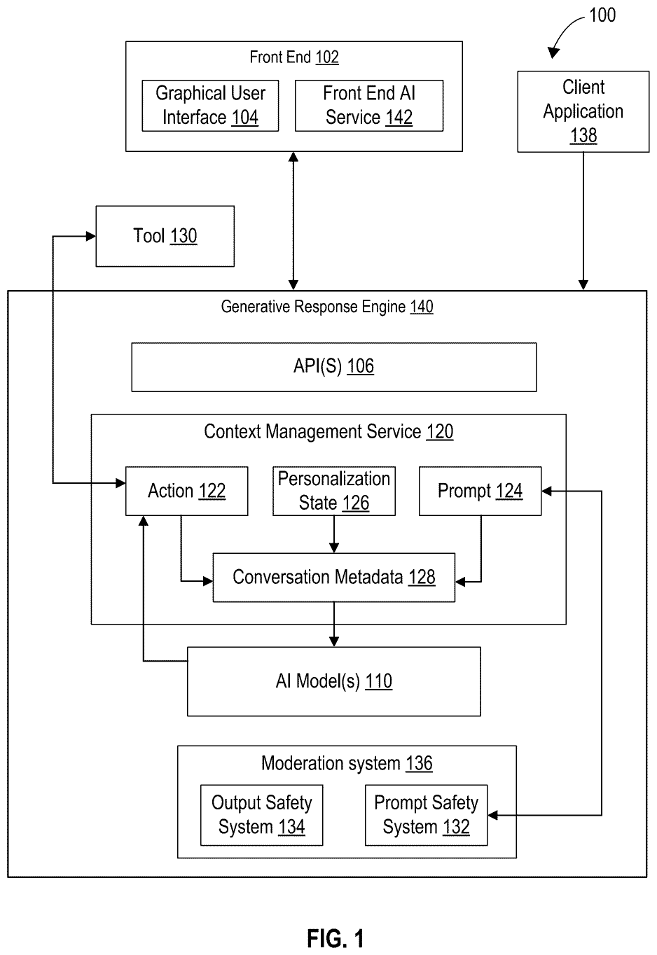

FIG. 1 illustrates an example AI assistant service supporting a generative response engine during inference operations in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

AI model(s) 110 are artificial intelligence (AI) models that can generate content in response to a prompt. The prompt can be from a human or a software entity (AI or applications, such as client application 138). The prompt is generally in natural language but could be in code, including binary. Some examples of AI model(s) 110 can include language models that generate language, such as CHATGPT, or other models, such as DALL-E or IMAGEGEN, which generate images, and SORA, which generates videos. CHATGPT, DALL-E, IMAGEGEN, and SORA are all provided by OPENAI, but AI model(s) 110 are not limited to AI provided by OPENAI. AI model(s) 110 can also be any type of generative AI and can include AI developed using various architectures such as diffusion models and transformers (e.g., autoregressive transformer architecture) and combinations of models. Some AI models are multi-modal models which can receive and output data in text, image, audio, etc.

In some instances, a language model, such as CHATGPT, can receive prompts to output images, video, code, applications, etc., which it can provide by interfacing with one or more other models, as will be addressed further herein.

AI model(s) 110 may be part of a generative response engine 140, where generative response engine 140 may include one or more components for supporting interaction with AI model(s) 110. Users can interact with generative response engine 140 through a front end 102 and applications can interact with generative response engine 140 through APIs 106. Front end 102 serves as the interface and intermediary between the user and generative response engine 140. It encompasses a graphical user interface 104 which may be used to provide input that facilitate communication with generative response engine 140 and AI model(s) 110. Generally, users interact through a graphical user interface 104 that often includes a conversational interface, and applications interact through the API 106, but this is not a requirement.

While some components are shown as being part of generative response engine 140 and some are outside of generative response engine 140, this is for illustration purposes and some components such as tool 130 might be part of generative response engine 140, and some components such as moderation system 136 might be outside of generative response engine 140. As used herein, generative response engine 140 encompasses deterministic services that are first-party services that prepare prompts to be sent to AI models, that are primitive level services that AI model(s) 110 can utilize to generate a response to a prompt. Services that are outside of generative response engine 140 are logically separate. For example, front end 102 might be a first-party front end (provided by the same party that provides generative response engine 140) but front end 102 is used to interface with generative response engine 140 rather than aid in developing a response to a prompt.

Some components of generative response engine 140 might be executed by computing programming units (CPU), and some components might be executed by graphical processing units (e.g., AI model(s) 110).

In some embodiments, client application 138 might provide a graphical user interface that is custom to client application 138 or can display graphical user interface 104 provided by generative response engine 140 provider.

Graphical user interface 104 is the platform through which users interact with the generative response engine 140. It can be a web-based chat window, an application, or any interface that supports data input and output. Graphical user interface 104 facilitates a conversation between the user and AI model(s) 110, as the user provides prompts in graphical user interface 104 to which AI model(s) 110 respond, and generative response engine 140 presents those responses in graphical user interface 104. In some aspects, graphical user interface 104 presents a conversational interface, which has attributes of a conversation thread between a user account and AI model(s) 110.

Graphical user interface 104 is configured to perform input handling and output presentation. The type of inputs that can be received can be relative to the specifics of generative response engine 140 and/or AI model(s) 110. For example, a language model is generally configured to accept text, but when the AI model is a multi-modal AI model, front end 102 can accept voice and images/video.

In some aspects, front end 102 can be a layer to accept any inputs, provide the inputs to generative response engine 140, receive outputs from generative response engine 140 and display the outputs. Graphical user interface 104 can accept any input types as part of the prompt, and front end AI service 142 can determine which AI model or collection of AI models are best suited to respond to the prompt. Front end AI service 142 can be one or more AI models that can be trained to determine which AI model should be used to respond to a prompt, and in some examples, can be used to improve prompts or provide additional configuration details, such as how long a reasoning model should spend processing a prompt. In general, front end AI service 142 can support functions of graphical user interface 104 by performing interference operations before a prompt is sent to generative response engine 140. Generally graphical user interface 104 is present on a client device, while front end AI service 142 might be present on the same client device or on a server in a data center.

Graphical user interface 104 is also configured to maintain the context of the conversation, which allows for coherent and relevant responses. For example, graphical user interface 104 is responsible for providing the conversation thread and other relevant context accessible to the front end 102 to the AI models along with the specific prompt. In an example, a conversation between the user account and the AI model(s) 110 can have taken several turns (prompt, response, prompt, response, etc.). When the user account provides a further prompt, the graphical user interface 104 can provide that prompt to AI model(s) 110 in the context of the entire conversation.

In another example, graphical user interface 104 might be configured to provide a system prompt along with a user-provided prompt. A system prompt is hidden from the user account and is used to set the behavior and guidelines for the AI model. The system prompt can be used to define the AI's persona, style, and constraints. There can be levels of system prompts. A highest level of a system prompt might be provided by the AI model(s) 110 provider and is meant to establish policies for the behavior of AI model(s) 110. This highest level of system prompt should be prohibited from being edited. A customization system prompt can be used to customize the behavior of the AI model and is often provided through an API call, or provided by a user account when creating a customized version of AI model(s) 110. A still lower level of system prompt might include hidden information about a task. This can include chain-of-thought from a reasoning model, or context about an application that AI model(s) 110 is working with to complete a task. Accordingly, graphical user interface 104 does not display all of the output of the AI model.

Graphical user interface 104 is also configured to display the responses from the AI model, which might include text, code snippets, images, or interactive elements.

In some aspects, AI model(s) 110 can provide instructions to front end 102 that instruct graphical user interface 104 about how to display some of the output from the AI model. For example, the AI model and/or generative response engine can direct graphical user interface 104 to present code in a code-specific format, or to present interactive graphics, or static images. In other examples, the AI model and/or generative response engine can direct graphical user interface 104 to present an interactive document editor where graphical user interface 104 can be presented with the document editor so that the user account and the AI model can collaborate on the document.

In some aspects, AI model(s) 110 can provide instructions to personalization state 126 to record facts in a personalization notepad. Personalization state 126 can store information received directly from the user account or inferred from prompts provided by the user account, and can be used to provide context to the AI model such that output is personalized for the user account. In some examples, front end 102 can be configured to notify the user account that a memory was created. Personalization state 126 can also include summaries of past conversation threads between the user account and the generative response engine 140, and/or a searchable index of past conversation threads. In this way, personalization state 126 aid generative response engine 140 and/or AI model(s) 110 to learn specific facts about a user account and recall past interactions. The past interactions can be used to guide future responses by generative response engine 140 and/or AI model(s) 110 such that generative response engine 140 and/or AI model(s) 110 becomes personalized to a particular user account.

Generative response engine 140 can provide one or more application programming interfaces (API(s)) 106. APIs enable developers to integrate the AI model's capabilities into external applications and services. APIs 106 provide programmatic access to generative response engine 140, allowing for customized interactions and functionalities. While APIs 106 are shown as part of generative response engine 140, in some examples, APIs 106 are part of front end 102. API 106 can refer to points of access to AI model(s) 110. In some examples, API 106 endpoints are located at context management service 120.

APIs 106 can accept structured requests containing prompts, context, and configuration parameters. For example, an API can be used to provide prompts and divide the prompt into system prompts and user prompts. In some aspects, APIs 106 can provide specific inputs for which AI model(s) 110 are configured to respond with a specific behavior. For example, an API can be used to specify an output in a particular format or structured output. For example, in the chat completion API, the API call can specify parameters for the output, such as the max length for the desired output, and specify aspects of the tone of the language used in the response. The output can also be structured output and in a data interchange format such as JavaScript object notation (JSON). For example, the input query may include a schema that identifies a specific output structure. Some common APIs are for participating in a conversation (Chat Completion API), for providing a single response (Completion API), for converting text into embeddings (Embeddings API), etc. The API can also be used to indicate specific decision boundaries that AI model(s) 110 might be trained to interpret. For example, the moderation API can take advantage of AI assistant service 100 via a content moderation decision-making. In the case of the moderation API and others, the API might give access to services other than the AI model. For example, the moderation API might be an interface to moderation system 136, addressed below.

Some other common APIs include the Fine-Tuning API, which allows developers to customize AI model(s) 110 of generative response engine 140 using their own datasets; the Audio and Speech APIs, which cause AI model(s) 110 to output speech or audio; and the Image Generation API, which causes AI model(s) 110 to output images (which may request operations of other models).

There can also be APIs that direct AI model(s) 110 and/or generative response engine 140 to interface with other applications or other generative AI engines. In such cases, the specific application or AI engine might be specified, or AI model(s) 110 might be allowed to choose another application of generative response engine 140 to use in response to a prompt.

As described herein, a Responses API can be an improved API for interacting with AI model(s) 110. Responses API can take as a parameter a response ID, which can be used to return AI model(s) 110 to a state that the model was in at a particular response, thereby allowing a user account or developer to recall a previous context without having to re-prompt AI model(s) 110 or having to replicate a previous series of prompts. Further, Responses API can facilitate function/tool chaining to enable execution of operations requiring several function/tool calls without the added overhead of responding to an API caller to call the function or tool. Instead, deterministic code associated with the API can be directed to call functions or tools (including other AI models) on behalf of the AI model, and return data resulting from the function or tool call to the AI model.

In short, graphical user interface 104 and APIs 106 can be used to provide prompts to AI model(s) 110 of generative response engine 140. Prompts are sometimes differentiated into prompt types. For example, a system prompt can be a hidden prompt that sets the behavior and guidelines for the generative response engine. A user prompt is the explicit input provided by the user, which may include questions, commands, or information.

Generative response engine 140 may also include a context management service 120. The function of context management service 120 is to manage and organize the flow of data among key subsystems, enabling AI model(s) 110 to generate responses that are contextually relevant, accurate, and enriched with additional information as required.

Action 122 facilitates auxiliary tasks that extend beyond basic text generation. In some aspects, action 122 can be actions that correspond to an API 106. In some aspects, action 122 can be agentic actions that AI model(s) 110 decide to take to carry out a user's intent as described in the prompt. For example, an action can be to call tool 130 or even other AI model(s) 110. Tools 130 can include internet browsers, editors such as code editors, other AI tools, etc. While tools are shown outside of generative response engine 140, some tools might be part of generative response engine 140 and some tools might be external tools.

Prompt 124 is the request or command provided by the user account through front end 102. In some aspects, prompt 124 can be further supplemented by a system prompt and other information that might be included by graphical user interface 104 or API 106 or associated with a custom AI model. In some aspects, prompt 124 can be modified or enhanced by AI model(s) 110 as addressed further below. Additionally, as the user account provides prompts and AI model(s) 110 provide responses, a conversation thread forms. As the user account provides a new prompt, this is appended to the overall conversation and added to prompt 124. Thus, a user account might think of a first user-provided message as a first prompt and a second user-provided message as a second prompt, and so on, but prompt 124 as perceived by AI model(s) 110 can include a thread of user-provided messages and responses from AI model(s) 110 in a multi-turn conversation. The actors in the conversation thread can be labeled so that AI model(s) 110 can review the turns of the conversation. Generally, prompt 124 will include an entire conversation thread, but in some instances, prompt 124 may be shortened if it exceeds a maximum accepted length (generally measured by a number of tokens).

In some examples, context management service 120 can also route prompts and response through moderation system 136. In some aspects, prompts are provided to prompt safety system 132 before being provided to AI model(s) 110. Prompt safety system 132 is configured to use one or more techniques to evaluate prompts to ensure a prompt is not requesting AI model(s) 110 to generate moderated content. In some aspects, prompt safety system 132 can utilize text pattern matching, classifiers, and/or other AI techniques.

Since prompts can evolve over time through the course of a conversation, consisting of prompts and responses, prompts can be repeatedly evaluated at each turn in the conversation.

Personalization state 126 can facilitate continuity and personalization in conversations. It allows the system to maintain user-specific context, preferences, or details that may inform future interactions. Personalization state 126 can include a memory file of persisted data from previous interactions or sessions that provide background information to maintain continuity. In some aspects, information can be recorded to personalization state 126 at the instruction of AI model(s) 110 when AI model(s) 110 identify a fact or data that it determines should be saved in memory because the fact and/or data might be useful in later conversations or sessions. In some aspects, personalization state 126 can also include synthesized concepts extracted from past conversation threads, and personalization state 126 can also encompass the ability of AI model(s) 110 to search through past interactions to find relevant information to a current conversation thread.

Conversation metadata 128 can aggregate data points relevant to the conversation, including user prompt 124, action 122, and personalization state 126. This consolidated information package serves as the input for AI model(s) 110. Conversation metadata 128 can label parts of a prompt as user-provided, AI model-provided, a system prompt, personalization state 126, data from action 122 or tool 130 (addressed below).

AI model(s) 110 are the core engines that process inputs (from context management service 120) and generate outputs. In some aspects, AI model(s) 110 may be a generative transformer, or autoregressive transformer, but could use other architectures. In some examples, the transformer is multi-modal transformer that can use audio tokens (or embeddings thereof), visual tokens (or embeddings thereof), and language (or embeddings thereof) as needed.

A core feature of AI model(s) 110 is to generate content in response to prompts. The prompt can be from client application 138 provided via graphical user interface 104. AI model(s) 110 can be configured to receive inputs via APIs 106 that provide guidance on a desired output. AI model(s) 110 can analyze the input and identify relevant patterns and associations in the data, and generate a sequence of tokens that are predicted as the most likely continuation of the input. AI model(s) 110 generate responses by sampling from the probability distribution of possible tokens, guided by the patterns observed during its training. Two features of the autoregressive transformer that result in this functionality are that the autoregressive transformer might use the decoder part of the transformer architecture and that it utilizes self-attention. By using the decoder part of the transformer architecture, the transformer focuses on predicting the tokens given the previous context tokens. The self-attention mechanism captures long-range dependencies amongst tokens, allowing it to generate contextually relevant responses (in text, audio, images, and video).

In some aspects, AI model(s) 110 can generate multiple possible responses before presenting the final one. AI model(s) 110 can generate multiple responses based on the input, and these responses are variations that AI model(s) 110 consider potentially relevant and coherent.

In some aspects, AI model(s) 110 can evaluate generated responses based on certain criteria. These criteria can include relevance to the prompt, coherence, fluency, and sometimes adherence to specific guidelines or rules, depending on the application. Based on this evaluation, AI model(s) 110 can select the most appropriate response. This selection is typically the one that scores highest on the set criteria, balancing factors like relevance, informativeness, coherence, and content moderation instructions/training.

In some aspects, an instruction provided by an API 106, a system prompt, or a decision made by AI model(s) 110 can cause AI model(s) 110 to interpret a prompt and re-write it or improve the prompt for a desired purpose. For example, AI model(s) 110 can determine to take a prompt to make a picture and enhance the prompt to yield a better picture. In these instances, AI model(s) 110 can generate their own prompts, which can be provided to tool 130 or provided to AI model(s) 110 to yield a better output response than the original prompt might have.

AI model(s) 110 can also do more than generate content in response to a prompt. In some aspects, AI model(s) 110 can use decision boundaries to determine the appropriate course of action based on the prompt. In some examples, a decision boundary might be used to cause the AI model to recognize that it is being asked to provide a response in a particular format such that the AI model will generate its response constrained by the particular format. In some examples, a decision boundary can cause the model to refuse to generate a responsive output if the decision is that the responsive output would violate a moderation policy. In some examples, the decision boundary might cause the AI model to recognize that it interfaces with another AI model or application to respond to the prompt. For example, when the AI model is a language model, it might recognize that it is being asked to output an image, and therefore, it interfaces with a model that can output images to provide a response to the prompt. In another example, the prompt might request a search of the Internet before responding. The AI model can use a decision boundary to recognize that it should conduct a search of the Internet and use the results of that search in responding to the prompt. In another example, the prompt might request that the AI model take an agentic action on behalf of the user by interacting with a third-party service (e.g., book a reservation for me at . . . ), and the AI model can use a decision boundary to recognize that it needs to plan steps to locate the third-party service, contact the third-party service, and interact with the third-party service to complete the task and then report back to the user that the action has been completed.

When AI model(s) 110 determine to take an agentic action on behalf of the user or to call a tool to aid in providing a quality response to the user account, AI model(s) 110 might call a tool 130 or cause an action 122 to be performed. As indicated above, tools 130 can include internet browsers, editors such as code editors, other AI tools etc. Actions 122 are actions that AI model(s) 110 can cause to be performed, perhaps using tool 130. As used herein actions 122 should be considered to cover a broad array of actions that AI model(s) 110 can perform with or without tools 130. Tools 130 are considered to cover a wide variety of services and software that encompass tools such as a computer operating system such that AI model(s) 110 can control the computer operating system on the user's behalf, to robotic actuators, to search browsers and specific applications.

Additionally, AI model(s) 110 can also generate portions of responses that are not displayed to the user. For example, AI model(s) 110 can direct front end 102 to provide specific behaviors, such as directions for how to present the response from AI model(s) 110 to the user account. In another example, AI model(s) 110 can provide response portions dictated by APIs 106, where portions of the response to the API might be for the consumption of the calling application but not for presentation to the end user. In another example, some AI model(s) 110 are reasoning models, which are AI model(s) 110 that are configured to output a raw chain-of-thought before preparing a final response to a prompt. The raw chain-of-thought might not be presented to a user account or application calling an API. Instead, another AI model might summarize the raw chain-of-thought into a more consumable and useful output for the user account or application.

In some aspects, the output of the AI model can be further analyzed by output safety system 134. While AI model(s) 110 can perform some of their own moderation, there can be instances where it is beneficial to have another service review outputs for compliance with a moderation policy. The use of dashed lines in FIG. 1 differentiates a path using output safety system 134 and not using output safety system 134.

As used herein, the present description may refer to the generative response engine or AI model(s) making a determination or reasoning prior to providing a response to a prompt. Determining can refer to a process by which an AI model outputs a response that provides a conclusion. In an example, an AI model can perform an inference operation to output a sequence of tokens, which output provides a determination. In such an example, the AI model might not have made any decision other than to sample particular tokens to provide an output, yet the response from the AI model might be a statement of determination. In another example, AI models can be trained to make particular determinations. In such examples, the AI model can be trained to make a decision, such as to cross a decision boundary to take an agentic action or to call a tool, etc.

Reasoning refers to simulating logical processes to draw conclusions or perform tasks based on provided inputs and learned information. Although the AI model might lack true understanding, the AI model uses pattern recognition and linguistic associations to emulate reasoning by linking related concepts and predicting outcomes. As used herein, the term reasoning by an AI model refers to the process performed by AI models known as reasoning models.

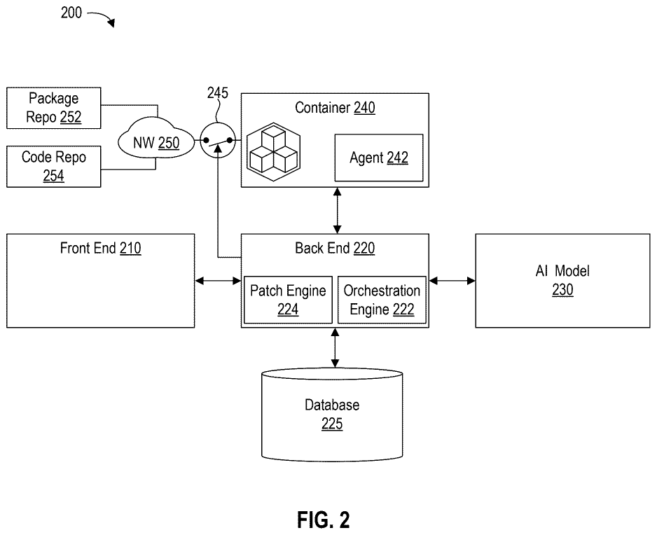

FIG. 2 is a conceptual block diagram of an automated software development system 200 using a generative response engine in accordance with some aspects of the disclosure. In some aspects, automated software development system 200 includes components of a generative response engine, such as a front end 210 (e.g., front end 102), back end 220, and AI model 230 (e.g., a transformer-based model, etc.).

In some aspects, AI model 230 is a foundation model, which is large-scale, pre-trained model built on vast and diverse datasets, designed to generalize across a wide range of downstream tasks such as language understanding, code generation, image analysis, and more. Foundation models leverage transfer learning to adapt efficiently to new problems with minimal additional training. An example of a foundation model is a reasoning foundation model that uses chain-of-thought reasoning in which the model generates intermediate logical steps to arrive at a final answer. This process mimics human problem-solving by structuring the reasoning path, which improves both the accuracy and interpretability of the model's outputs. In some cases, the foundation model can be fine-tuned for specific tasks, such as software development, and the model can be pruned to reduce weights and its ability to perform general-purpose reasoning, thereby using fewer computational resources and improving efficiency for targeted applications.

In some aspects, front end 210 can be a client application that is presented at an edge device and can be configured in various forms, such as a native application, a cross-platform application using a webview renderer (e.g., Electron, etc.), or a web browser instrumented application with instructions (e.g., a JavaScript bundle such as React or WebAssembly bytecode, etc.). In some cases, client application can be retrieved from cloud computing service (e.g., as a JavaScript bundle) or may be rendered via cloud computing service via different techniques (e.g., server-side rendering, partial hydration, etc.).

The back end 220 provides an interface for front end 210 to interact with various components on a server or cloud. For example, back end 220 includes various services such as database 225, inspection services to analyze the safety of prompts, and interface with AI model 230. Back end 220 includes orchestration engine 222 and patch engine 224 to implement software development services. Orchestration engine 222 is configured to receive instructions from front end 210 and spawn a container 240 including a development environment. In some aspects, an edge device (e.g., controlled by a user) can configure various aspects such as an execution environment. The execution environment includes a base system (e.g., a Linux distribution) and can include instructions to build the base environment (e.g., a docker file). The execution environment can also include additional instructions to instrument the development environment with various services, packages, package managers, servers, configurations, SDKs, and so forth. For example, the execution environment can include instructions to include a package manager (e.g., pip for Python, cargo for rust, and npm for JavaScript, etc.) as well as various dependencies. As an example, a dependency can be a development tool (e.g., a linter for checking for errors before building, a prettier to consistently format code, etc.), a library for interacting with a database, a framework (e.g., React, etc.), a development package, and so forth.

Orchestration engine 222 receives various information from front end 210, including the execution environment, and spawns container 240 including the development environment (not shown) and service 242.

In some aspects, container 240 has a lifecycle that is suitable for network applications. In particular, an instance of a container 240 is created, started, optionally paused, stopped, and eventually removed. At creation (e.g., docker create or docker run), container 240 is built from a specified image and includes an isolated environment, which contains the filesystem, environment variables, entrypoint, and network settings. When started, container 240 runs a defined process (e.g., in the dockerfile) with limited access to the host system. Container 240 is a sealed environment and can be accessed through services installed within the dockerfile. For example, access to container 240 (e.g., files, APIs, or other functionality) is provided via services installed and configured at build time (e.g., in the docker configuration or the dockerfile). After container 240 is executed, container 240 can be accessed via the defined services, and there is implicit access to its contents. Once the process ends, container 240 stops. Any changes made within container 240 (e.g., to the filesystem) are generally ephemeral and are lost when the container is stopped or removed.

In some aspects, container 240 may include service 242 that is configured to interact with AI model 230. For example, AI model 230 may be executing in specialized hardware for floating point operations (e.g., a graphical processing unit (GPU), a multiply accumulate (MAC) unit, etc.). The container 240 can expose a port to allow service 242 to interact with AI model 230 and perform functions associated with AI model 230. In some cases, various actions by AI model 230 can compromise the actions performed within container 240, such as attempting a denial of service attack, posting malicious social media content, and so forth. Even though container 240 is an isolated environment, it can be sealed from external access, and internal commands may be permitted. For example, container 240 may execute shell commands (e.g., curl, etc.) or other applications (e.g., ping, etc.) that can be accessed for various malicious purposes.

In some aspects, switch 245 is configured to permit or deny access to external network 250 by container 240. Switch 245 may be a logical network interface of container 240, and switch 245 is illustrated to show that back end 220 controls whether container 240 can access external network 250 (not the internal network). In some aspects, switch 245 can be enabled for an initialization period associated with configuring the container. In this case, container 240 can access network 250 to access package repository 252 during an initialization period associated with container 240. Package repository 252 can include various software packages, container images, and other components to generate and configure container 240. In some aspects, orchestration engine 222 is also configured to cause container 240 to access code repository 254 to locally clone a public or private repository. For example, orchestration engine 222 can access GITHUB (either using a public interface or a private repository based on a stored secret of the user) and retrieve and store code repository 254 within container 240.

Switch 245 may disable access to network 250 after all code and packages are installed in container 240 and the initialization period ends. For example, switch 245 is enabled before AI model 230 is provided access to service 242 of container 240 and is disabled when AI model 230 has access to service 242 of container 240. In this case, container 240 is unable to access external network 250 and the data, packages, code, and other content installed on container 240 can be accessed via an internal interface (e.g., a network file system service). In this way, container 240 cannot perform any malicious actions outside of its environment and any harmful activities are restricted to its environment. In some aspects, switch 245 can be configured using an internal interface (e.g., iptables in a Linux container) or an external interface (e.g., via a control plane associated with a container service).

In some aspects, switch 245 can be configured based on user control. For example, a user, as part of a project or an execution environment, may elect to enable limited or unlimited network access. For example, the user may configure container 240 to control the scope of network access via a configuration to restrict access to particular domains and protocols. For example, a user repository may be focused on implementing a new service based on an API (e.g., weather. acme. com), and internal and external network access can be limited to network traffic to and from that fully qualified domain name. In other examples, network access can be time-limited based on an external request to an external service, requiring a response within a duration (e.g., 5 seconds). In some cases, container 240 could include default configurations that identify advertent or inadvertent misbehavior, such as a loop that continues to execute an identical network request based on an improper configuration. Table 1 below illustrates an example of rules that can be applied to a firewall of container 240, such as a command-line utility iptables, which configures the packet filtering rules of the Linux kernel firewall.

TABLE 1

# Default policy: drop everything
iptables -P INPUT DROP
iptables -P OUTPUT DROP
iptables -P FORWARD DROP
# Allow loopback for local apps
iptables -A INPUT -i lo -j ACCEPT
iptables -A OUTPUT -o lo -j ACCEPT
# Allow incoming established connections (like replies)
iptables -A INPUT -m state --state ESTABLISHED,RELATED -j
ACCEPT
# Allow outgoing DNS (UDP port 53) to your resolver
iptables -A OUTPUT -p udp --dport 53 -j ACCEPT
# Resolve acme.com to IP(s)
# (Always resolve outside iptables, e.g., use ‘dig‘ or ‘nslookup‘)
ACME_IP=$(dig +short acme.com | head -n 1)
# Allow outgoing traffic to acme.com IP on any port
iptables -A OUTPUT -d $ACME_IP -j ACCEPT

AI model 230 is configured to interact with service 242 of container 240 to generate code changes and other modifications within container 240 based on a natural language instruction. For example, service 242 can provide terminal access to AI model 230 (e.g., STDIN, STDOUT, STDERR) and allow AI model 230 to use the command line interface (CLI) to interact, read, and modify the copy of local code repository (e.g., cloned from code repository 254), run tests, and other developer functions. The service 242 can also include an interface that exposes an API to make modifications via commands that AI model 230 is trained with to provide discrete functions associated with a software development task. For example, AI model 230 can access a local GITHUB repository (e.g., the locally cloned repository within container 240) to create, read, update, and delete code files using an API. The AI model 230 behaves like an autonomous developer and reads code context, reasons about functionality or bugs, and produces inline edits, new code, and removes code as needed. The AI model 230 is able to perceive the entire context of the project while isolating changes to container 240.

Conventional automated development techniques either use direct access to a live system to directly modify files without network isolation (e.g., within a local development environment) and risk potential malicious behavior, or an incomplete understanding of the environment based on modification of a part of a repository within a web-based environment. For example, the local configuration can include various settings (e.g., a linter, a configuration file, etc.) and copying the code from a web-based front end may use additional modification to match the local development environment. For example, if the noImplicitAny flag is set to false in a local TypeScript configuration file and the code has implicit any return values, copying the changes from a web-based environment can create additional errors within the copied instructions based on differences in the local development environment and the web-based front end.

In some aspects, AI model 230 is configured to execute in a different hardware environment and can access service 242 to interact with the software development environment. For example, AI model 230 is typically executed at inference (e.g., at runtime) on specialized hardware, such as GPUs or custom accelerators, such as tensor processing units (TPUs), that are configured for large-scale matrix math. Machine learning (ML) inference and training involve massive parallel floating-point computations (e.g., matrix multiplications) that are faster on GPU hardware. For example, AI model 230 may require access to high-throughput memory (e.g., high bandwidth memory (HBM)) and parallel processing cores that are not available in conventional CPU architectures.

Multiple instances of automated software development system 200 may execute in parallel to handle different tasks. For example, a first instance of automated software development system 200 may be adding database integration, a second instance of automated software development system 200 may be adding authentication, and a third instance may be adding a new feature.

After the task by AI model 230 is completed, orchestration engine 222 is configured to use service 242 to extract the development data associated with the task, which includes modifications, commands, changes, and any events that occurred within container 240 while being controlled by AI model 230. Orchestration engine 222 stores the development data in database 225.

Patch engine 224 is configured to access the development data extracted by orchestration engine 222 and generate a change proposal associated with code repository 254. For example, patch engine 224 can run commands to deterministically produce a diff of all the changes made within the development data. In some cases, patch engine 224 may be configured to receive the development data and identify the various changes (e.g., using a deterministic diff) and store the modifications in database 225.

In some aspects, AI model 230 can generate and output the diff to database 225. For example, AI model 230 can call a deterministic function. In some cases, AI model 230 may be able to reason and generate the diff during inference. In some cases, AI model 230 can also review the changes to validate that its reasoning corresponds to the generated instructions.

Patch engine 224 (or AI model 230) generates a diff that identifies a representation of changes (e.g., insertions, deletions) in a particular file. AI model 230 can be configured to output structured information using various techniques, such as a data validation function or library (e.g., zod) that validates data types that cross system boundaries. Table 2 below illustrates a diff command of two files (e.g., ./a/hello.txt and ./b/hello.txt) and a corresponding output format that identifies line-based changes (e.g., @@−1+1,2 @@ indicates to remove a line, and add two, followed by the lines to remove based on a leading “−” lines to add based on a leading “+”).

TABLE 2

diff --git a/hello.txt b/hello.txt
index e69de29..a3c1234 100644
−−− a/hello.txt
+++ b/hello.txt
@@ −1 +1,2 @@
−Hello world
+Hello world!
+Goodbye world.

In some aspects, automated software development system 200 is configured to generate a change proposal associated with code repository 254. For security purposes, automated software development system 200 may not be configured to directly access code repository 254 and can generate the change proposal for the user's review. The change proposal also includes additional information that can be used to generate all changes based on a state of code repository 254. For example, the change proposal can include a source branch containing proposed changes, a target branch where the changes are intended to be merged, a commit history that outlines the modifications, a diff showing line-by-line changes to files, and optional metadata such as a title, description, reviewers, and discussion comments for code review and collaboration. For example, a commit is a snapshot of a repository at a specific point and links to a tree of that snapshot. The commit includes a pointer to a tree object (e.g., a tree of files), a list of parent commits (for history), and other metadata (e.g., author, timestamp, commit message, etc.). The commit points to the new tree and the previous commit and allows a graph to be constructed to identify changes to be made out of order.

In some aspects, the change proposal, or at least parts of the change proposal and generated code, are provided to back end 220 based on user input. For example, front end 210 can display various options associated with the change proposal, such as the ability to view and generate a pull request. Based on the user input, back end 220 accesses database 225 and generates the change proposal.

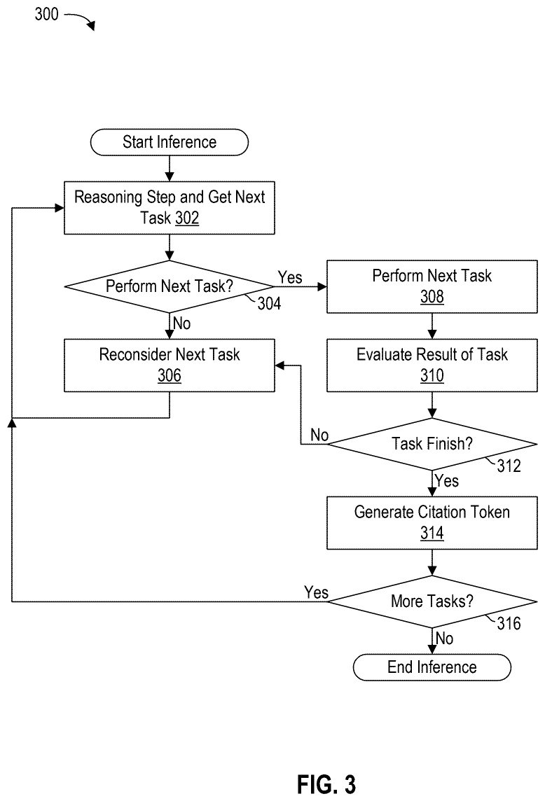

FIG. 3 illustrates a flowchart of a process 300 for generating citation tokens during an automated software development task in accordance with some aspects of the disclosure. In some aspects, process 300 can be executed by AI model using a computing system to implement an automated software development system (e.g., automated software development system 200 of FIG. 2). Process 300 is initiated based on a software development instruction from a user that includes a natural language task (e.g., refactor this library using a generic, modify this project to use a different component library, generate unit tests based on different network failure scenarios and fix any failed unit tests, etc.). In some aspects, process 300 is an inference cycle illustrating operations that a foundation model performs using stepwise reasoning and conditionally performing actions, similar to reasoning steps performed by a person's analytical process system in Dual Process theory.

At block 302, the AI model is configured to perform an initial reasoning step based on the higher-level software development task and decomposes the task into smaller, concrete sub-tasks using its internal chain-of-thought capabilities. During this phase, the AI model may analyze the current state of the codebase, retrieve relevant files or function definitions, and prepare a plan. For example, the AI model may map endpoints associated with modules, decide where logging hooks should be injected, and generate candidate code snippets for insertion points. The initial reasoning step can be considered a dynamic task stack, a queue, or a directed acrylic graph (DAG) if there are dependencies that are dynamically modified during the inference. For example, each sub-task is pushed onto the stack in a planned execution order. At the end of each reasoning step at block 302, the AI model retrieves the next task from the stack.

At block 304, the AI model may determine whether to perform the next task based on additional information. For example, the AI model may use the inner monologue to identify any potential inferences that are being made in the next task and identify potential issues in light of the current code base. For example, previous tasks can have modified the trajectory of the task and, at block 304, the AI model determines whether the next task is ready.

If the AI model determines not to perform the next task, at block 306, the AI model reconsiders the next step and, for example, generates an inner monologue that identifies the issue raised at block 304. For example, at block 304, the AI model may reason that a function returns a null value based on a condition later identified (e.g., after the initial reasoning) by the ML model and, at block 306, the AI model can use the information pertaining to the null value to generate an inner monologue regarding this issue. For example, the AI model may reason that “function A returns a null value when a function B times out because there is no graceful handling of the network request.” The AI model appends this inner monologue to the context stack and proceeds back to block 302 to reason about the next step.

If the AI model determines not to perform the next task, at block 308, the AI model performs the next task. Non-limiting examples of the next task can include modifying the code via an API service (e.g., service 242, etc.), refactoring existing code, implementing new services and APIs, migrating various functions to use a different library, and so forth. For example, if the next task is “add input validation to this API route”, the AI model may generate a code block that checks request parameters, returns appropriate error responses, and inserts this block at the correct line in the target file. In another aspect, the AI model can be refactoring code, such as renaming variables, extracting methods, reordering logic, or abstracting libraries to make the code base consistent and predictable. In this case, the model may transform the existing code while preserving behavior. In some aspects, the AI model may also generate new unit or integration tests, adapt existing test cases, or insert test stubs to ensure the change is verifiable. The AI model can also be asked to perform an analysis of a code repository based on a prompt and respond with a natural language response (e.g., identification of the purpose of a function, explanation of a dependency, explanation of the syntax of a complicated request, etc.).

At block 310, the AI model is configured to evaluate the task phase. For example, the AI model can use multiple layers of validation to ensure that the produced code safely and correctly fulfills the intended goal. In one example, the AI model may perform semantic checks and execute various analyzers, linters, or type checkers to confirm that the new code integrates cleanly with the existing codebase and does not introduce syntax errors or type mismatches. The AI model may also execute unit or integrated tests to validate that the new code does not have any unexpected side effects. These tools may be command line functions, and the AI model can interact with the container with a terminal emulation function that emulates terminal access by a developer and formats input and output of the terminal in a structured format the AI model understands (e.g., JavaScript object notation (JSON), etc.).

The AI model may also run unit and integration tests to verify that the behavior aligns with the task's original requirements and does not break unrelated functionality. For example, the AI model executes existing test suites and new tests generated at block 308. The AI model can also detect malicious or unintended operations by analyzing the generated code for suspicious patterns, such as unauthorized network calls, file system writes outside expected paths, or embedded secrets. In some cases, the AI model can compare the generated code against a policy of safe coding practices or using a static security scanner. The AI model may also execute the generated code in isolation, capturing output logs, runtime exceptions, or suspicious system calls.

At block 312, the AI model determines that the task was completed successfully based on whether any of the validation functions fail at block 310. For example, if any of these checks fail (e.g., a unit test fails, security policies are violated, or the behavior diverges from the intended outcome), the AI model deems the actions to complete the task as invalid. In the case of task failure at block 312, the AI model may automatically revert the change and push the task back onto the task stack for reconsideration at block 306. In the case of task success at block 312, the AI model is configured to generate citation tokens and push the citation tokens into the development data associated with the software development task. In some cases, at block 312, the AI model can generate citation tokens to indicate failure of an operation and provide a reason for that failure. For example, in some cases, the natural language instruction can be on an incorrect user understanding or inference, and the AI model may generate citation tokens to provide evidence of why a certain task was unable to complete to help explain the reasoning process.

In some aspects, a citation token is metadata attached to a code edit, output, or generated diff that records where the edit came from in the AI model's reasoning process. A citation token provides evidence of relevant events used or performed by the AI model to achieve the result and enables an audit trail that can be displayed back to the user. For example, an automated software development system should track the prompt or instruction that led to the change, a chain-of-thought step that produced the change, an external source the model may have referenced (e.g., a doc snippet, a training example, reviewed code, the model identity, and so forth. In one example, the citation token may be a reference that identifies different types of information for auditing the software development process.

Citation tokens can have different types, such as a file citation to a file event and a command citation to a command that was executed. Other types of citations may be relevant based on the task, such as a source of a fact or decision. In one aspect, a file citation may be a reference to a file and an identification of changes applied to the file, similar to a diff. For example, a citation token of “~/src/store.tsx@@−31+31 , 32, 33, 34 @@” indicates that line 31 was removed and new lines 31-34 were added to the store. tsx file. In this way, the file citation can identify changes that were made by the AI model, which can in turn be used to generate a detailed summary with an audit trail to the user. File citations can have different forms and my use a demarcation strategy to identify different features (e.g., a start of the citation token, and end of the citation token, a symbol that demarcates different properties, etc.) In another example, the citation may include a reference to the file (either absolute or relative) with an identification of changes with various types of characters (e.g. Unicode), such as [symbol] F:some/filename.extension†L9-L11 [symbol] (e.g., with the brackets being lenticular brackets to distinguish typical grammatical brackets).

Another type of citation token is a command citation. A command citation can have a different format from the file citation and may reference structured data associated with input and output of a terminal. For example, a command citation may include information that identifies a context of the AI model relative to input and output, such as an identification of the command and any corresponding input parameters demarcated with a line identifier. The line identifier is a unique identifier of an input or output turn by the AI model within a terminal log, which is generated by a worker service (e.g., of back end 220) as the AI model inputs and outputs into the terminal of container 240. The line identifier allows the automated software development system to identify the input command and the output of that command, generate a summary of the changes and commands used by the AI model during the software development task, and display an audit train to a user.

In some aspects, citation commands can also comprises different types of command citations. For example, the citation command can include an input command citation and an output command citation. An example input command citation may correspond to the precise input (e.g., [symbol] npx vitest run tests/math-utils.test.ts CLI run unit tests [symbol] . In some cases, the input command citation can also include a summary with a delimiter that can be used to present to the user (e.g., [symbol] execute the unit tests to validate the changes†npx vitest run tests/math-utils.test.ts CLI run unit tests [symbol] ). An example output command citation can also identify corresponding output and a summary of the failure. Table 3 below illustrates an example of a shell output and an output command citation generated from a unit test.

```
TABLE 3
> npx vitest run tests/math-utils.test.ts
  DEV v1.6.0 / Node v20.15.0
  ✓ adds numbers (3 ms)
  ✓ subtracts numbers (1 ms)
  ✓ multiplies numbers (2 ms)
  ✓ divides numbers (1 ms)
  ✓ handles division by zero (edge case) (0 ms)
  ✓ computes factorial (recursive) (2 ms)
  ✓ computes factorial (iterative) (1 ms)
  ✓ rounds numbers to two decimals (2 ms)
  X generates a random integer outside of range R (3 ms)
```

| | |
|---|---|
| Test Files | 1 passed (1) |
| Tests | 8 passed (9) |
| | 1 failed (9) |
| Start at | 10:42:15 |
| Duration | 24 ms (transform 5 ms, setup 4 ms) |

[Test failed because null exception error†X generates a random integer
outside of range R (3 ms)]

In other aspects, the command citation tokens can be further grouped based on various logical groups. Non-limiting examples include file system command citation (e.g., for file system navigation), network system command citation, package command citation (e.g., npm install package-name), etc. In other cases, the citation tokens can also be associated with API features associated with the AI model such as structured output, tool calling, etc.

In other aspects, the citation tokens may be configured to annotate a text description. For example, the AI model can generate markdown (MDX) content for simple presentation to the user, and the markdown content can be annotated with a description of the event and the citation token. For example, “Added the new feature you requested in code.py [symbol] F:code.py†L2 [symbol] ” is an example test description annotated with evidence to indicate the code change. In some cases, the citation token can be replaced dynamically (or statically) with a component (e.g., a button that reveals the code diff), a hover card, or other suitable variations.

In some aspects, the AI model may be trained (e.g., using reinforcement learning) to generate the citation tokens at block 308 based on events the AI model performs. For example, upon successful adoption of the change or upon failure of an ability to complete a certain aspect of the natural language task, the citation tokens may be recorded into development data for presenting to the user at block 314. For example, the AI model is configured to generate citation tokens as a result of a specific action, whether that action succeeds or fails.

At block 316, the AI model is configured to determine if the task stack has additional tasks. If there are additional tasks, the AI model returns to block 302 and begins reasoning about the next task. In this case, the context of some of the tasks may have shifted due to changes performed by the AI model, and the AI model further evaluates additional changes. For example, the AI model can identify tasks that are no longer necessary, identify additional tasks, or remove tasks that are not necessary based on the changes.

Process 300 performed by the AI model is a loop that mirrors how skilled human developers think and work. In this loop, the AI model deliberately plans tasks, breaks down tasks, and reconsiders the tasks in light of new information. Using this deliberative process, similar to the rational system proposed by Dual process theory, the AI model plans, acts, and re-evaluates the software development task to tackle complex software tasks. Citation tokens generated by the AI model record information of the software development task to generate an audit trail for every change the model makes and links each action back to pertinent information to understand the modifications. The automated software development process allows transparency, and developers or reviewers can inspect the generated diffs and validate that the proposed modifications by the AI model are correct, safe, and aligned with the original goal before accepting them into a production branch.

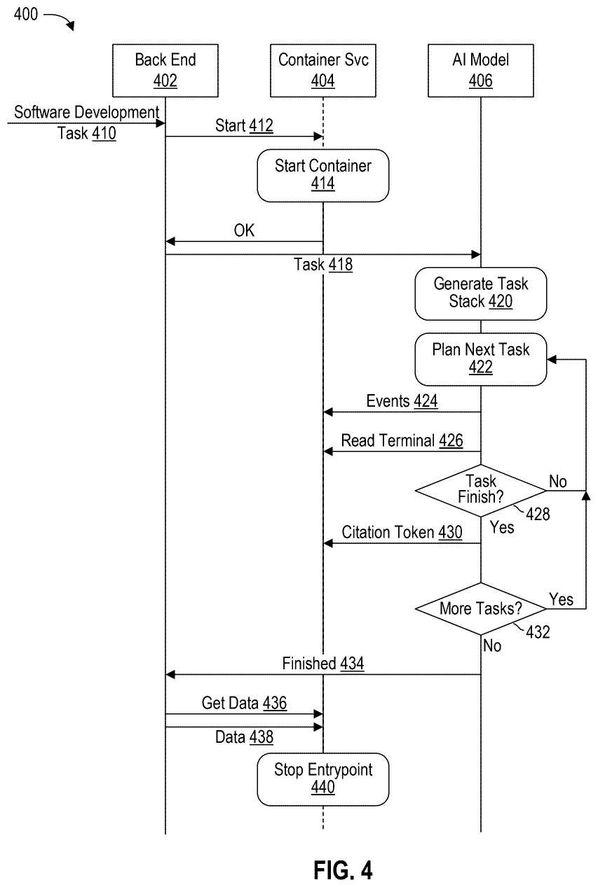

FIG. 4 illustrates a sequence diagram of an automated software development system 400 that generates citation tokens for generating an audit trail for a software development task in accordance with some aspects of the disclosure. In some aspects, automated software development system 400 includes a back end (e.g., back end 220), a container service 404 (e.g., dedicated hardware in a data center), and an AI model 406. The AI model can be executed in specialized hardware configured for parallel floating point operations and high bandwidth memory. For example, the AI model can be executed in a GPU cluster (e.g., NVIDIA H100 clusters, NVIDIA GB200 NVL72 platform, etc.) or specialized processing units configured for tensors and other large matrix operations.

Initially, back end 402 receives a software development task 410 from a front end (e.g., executing on a client device). Back end 402 may execute a worker that stays alive for an extended period for handling a long task and is configured to continuously handle tasks, API requests, and respond to messages from different systems to complete a task that may use many different parts (e.g., software development task 410). The software development task 410 includes identification of a code repository and a natural language task, similar to how a more experienced developer would task a junior developer. The software development task 410 can include additional details, such as authentication information, a branch, and an execution environment, related to the software development task. Back end 402 sends a start instruction 412 to the container service to spawn a container based on particulars of software development task 410 (e.g., user credentials, code repository, etc.), and container service 404 then starts a container at block 414. In some aspect, block 414 can include various operations associated with configuring the development environment of the container, such as cloning a repository (e.g., identified in software development task 410), installing dependencies, configuring user secrets, configuring network access, etc.

Once the container is active and ready (as indicated by the solid vertical line in FIG. 4), the container may send a signal such as OK to back end 402 indicating that the container is ready. In response to OK, back end 402 sends task 418 including natural language instructions (e.g., from software development task 410) to AI model 406. In some aspects, the container may also be configured to send task 418 to the model 406.

At block 420, AI model 406 is configured to generate a task stack that comprises discrete, concrete tasks that would be iteratively performed by a developer. Rather than attempting to promulgate changes to the code repository (e.g., cloned by the container) in a single step, AI model 406 iteratively modifies the code to build feature. For example, the AI model may first be configured to refactor a type definition for a particular feature to support generic types, which uses multiple steps to implement the changes and validate the separation of concerns between the different types and any corresponding functions. In some aspects, the task stack can be considered a dynamic task stack, a queue, or a directed acrylic graph (DAG) if there are dependencies that are dynamically modified during the inference. The task stack is dynamically modified based on reasoning performed by AI model 406, similar to how a developer performs changes, evaluates changes, and modifies plans based on changes to perform software development task 410.

At block 422, AI model 406 is configured to plan and perform the next task. AI model 406 plans the next task by evaluating if any changes to the code repository in the container were made that could possibly conflict with the task stack. For example, AI model may determine that a property of a type definition or a class can be removed, but during unit testing, the AI model can determine that the property is present in certain conditions and therefore the property is optional (e.g., nullable). An as example, in a type definition for a patent application, a patent number and a patent issue date are optional properties because they are properties that may result.

As part of block 422, AI model 406 may generate events 424 to perform in the container in connection with the next task. Events 424 can be a single task (e.g., execute a unit test), but may also require multiple tasks (e.g., edit a static function library and then perform unit and integrated tests to validate the changes). Non-limiting events 424 include modifying the code via an API service (e.g., service 242, etc.), refactoring existing code, implementing new services and APIs, adding a library, migrating a service to use a different library, changing a configuration of a server or service, and so forth. Events 424 can also include accessing a terminal (via a terminal emulator) of the container via an interface and inputting various commands to validate the changes, perform unit or integrated tests, execute various developer tools such as a linter, etc.

As part of block 422, AI model 406 may also generate citation tokens corresponding to events 424. For example, AI model 406 learns to output different events in a structured form that identifies file, file information, command, options associated with command, and other information. In some aspects, AI model 406 may generate different types of citation tokens to provide evidence and an audit trail associated with its sources, context, and actions. For example, AI model 406 can indicate cite to external information that was identified to generate a response, allowing a user to validate the actions performed.

After planning events 424 at block 422, AI model 406 then performs the various events 424 in connection with the task. For example, AI model 406 can sequence events together in a specified order, such as modify the code and then execute a unit test to validate the modification.

As part of the task planned at block 422, AI model 406 is also configured to get a terminal state 426 of the container. Events 424 may include terminal commands that have varying durations, ranging from milliseconds to several minutes. For example, a unit test may take milliseconds, a full integrated test may take several seconds, and a build step may take several minutes based on the complexity of the code. In this case, AI model 406 is configured to retrieve the terminal state 426, which can include content generated based on events 424, before determining a next task or step. For example, unit tests and integrated tests can output results via the terminal. A build step can also provide output on the terminal, which AI model 406 retrieves in connection with reading the terminal state 426.

Although, automated software development system 400 illustrates AI model 406 as providing events 424 and retrieving terminal state 426 directly to the container, this is for illustrative purposes. In some aspects, AI model 406 may relay events 424 and terminal state 426 through back end 402. For example, back end 402 may include a worker that is configured to periodically read the terminal of the container to facilitate asynchronous interactions between the container and AI model 406 due to the varying time duration of different terminal commands. The worker of back end 402 may also render a state of the terminal at a discrete time (e.g., removing control codes that alter presentation of the terminal in time such as a progress bar), and generate structured data, which corresponds to input turn and output turn. Using a data structure that includes an array of input turns and output turns helps AI model 406 to process and understand input and output for planning any subsequent tasks and events.

At block 428, AI model 406 determines whether to the task succeeds. For example, AI model determines that the unit tests pass, linter analyzes cleanly, or the application successfully builds at block 428. If the task does not succeed, AI model 406 returns the process to block 422 to plan and retry the task. In this case, AI model 406 can use any information gleaned from the previous iteration of the task to further plan a different version of the task. For example, the test may fail due to a null (or undefined) value, and AI model 406 can generate an inner monologue that indicates “the date value is null based on a condition.” AI model 406 uses this inner monologue and generates an improved task that addresses the issues brought to light based on the analysis.

If the task is determined to succeed, AI model 406 provides the citation tokens 430 (or citation token for a single event 424) identifying modifications or commands associated with events 424. In some aspects, the container is configured to store the citation tokens with development data, for example, a log of events that occurred. The development data is stored locally in the container in some examples, but AI model 406 may provide citation tokens to another storage device (e.g., orchestration engine 222)

AI model 406 then determines if there are additional tasks to perform in the task stack at block 432. If there are more tasks, AI model 406 returns to block 422 to plan the next task in the task stack. If there are no further tasks, AI model 406 then sends a finished signal 434 or some indication that the task is completed to back end 402. For example, the worker of back end 402 receives the finished signal 434 that indicates completion of software development task 410.

Back end 402 then sends a get data request 436 to the container to retrieve the development data generated by AI model 406 during software development task 410 and container 404 returns the development data 438. In some cases, the development data can be stored by back end 402 (e.g., using block 422) during inference of software development task 410. At block 440, the container is configured to stop the entrypoint associated with container, which causes container to stop.

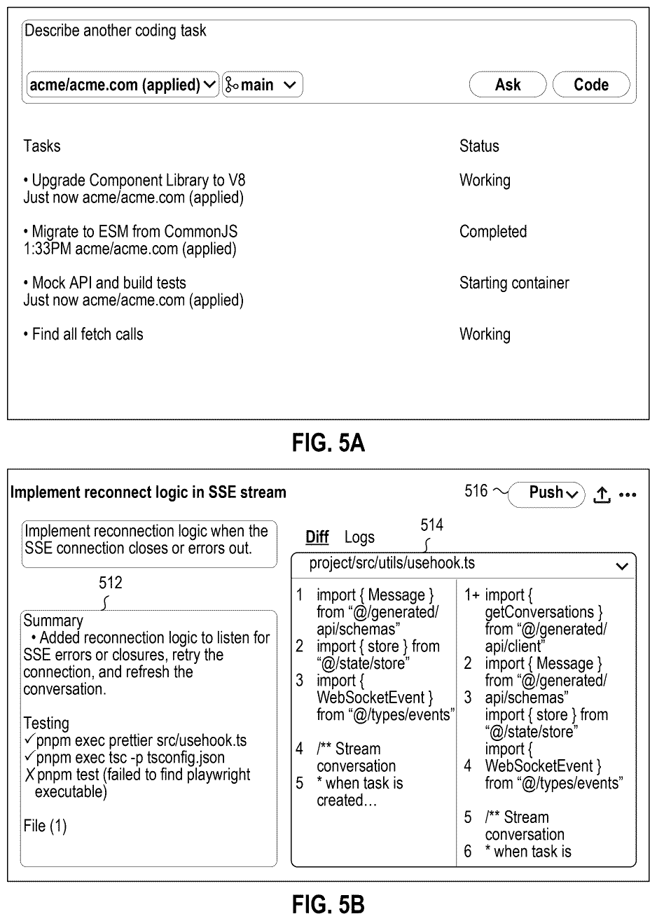

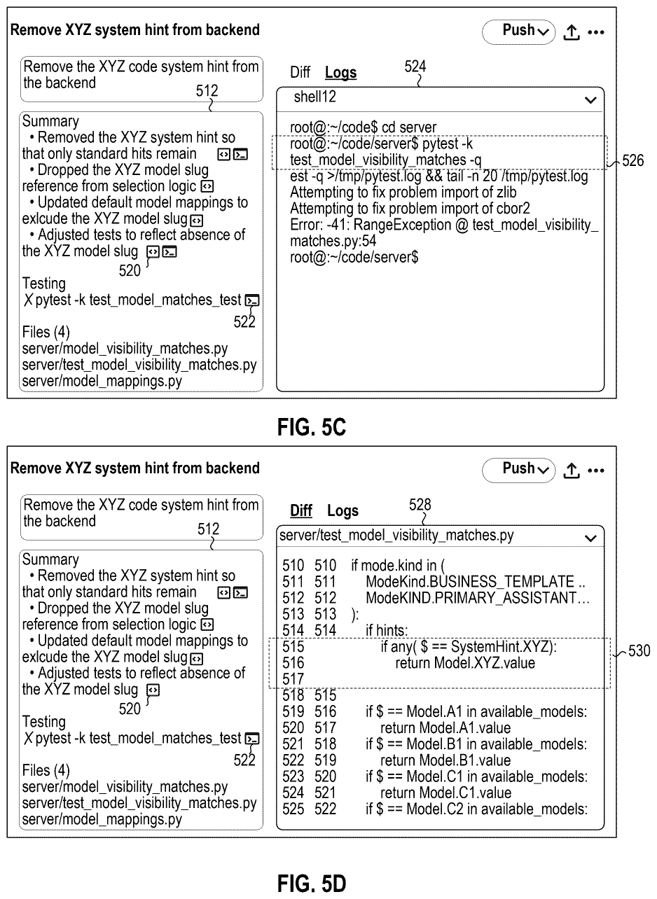

FIGS. 5A-5D illustrate various screens and conceptual diagrams of an automated software development system using a generative response engine in accordance with some aspects of the disclosure.

FIG. 5A illustrates a user interface displayed by a client device after the automated software development system completes a task. For example, FIG. 5A illustrates implementing a client application with reconnection logic for a server sent event (SSE) service by a server. The user interface includes a summary that is extracted from the data generated by the ML model that identifies various actions that occurred during the task, including executing the prettier (e.g., code formatting) and a typescript transpiler (tsc) to validate the changes. The user interface also includes diff interface to present the changes to the user in a manner that allows the user to easily validate the changes.

FIG. 5B illustrates the user interface illustrating a result of a software development task (e.g., software development task 410) and options for generating a change proposal. A summary 512 can be generated based on change tokens that identifies citations to changes invoked by the AI model, such as identification of features that were changed in natural language, identification of files that were changed, and identification of commands input into the container. The user interface can also display a diff 514 to allow a user to compare modifications of code and configurations before and after the software development task. The user can also deploy change proposals for merging the changes into a repository via button 516. For example, button 516 can be invoked to display different options to generate a change proposal (e.g., a PR, a git apply, or a manual patch). In some aspects, the PR is a collaborative feature commonly used on platforms like GitHub or GitLab to allow developers to propose changes from one branch to another while enabling code review, comments, CI integration, and approval workflows.

FIG. 5C illustrates the user interface of a result of a software development task with links to citation sources in accordance with some aspects of the disclosure. For example, summary 512 in this example identifies different inputs that were deployed by file changes and terminal inputs based on citation tokens. For example, summary 512 can include button 520 that is associated with a citation token for displaying the file (e.g., the modified file in any corresponding form such as a diff based on the citation token, or the code itself without any references to changes). Summary 512 can also include button 522 for viewing the commands applied to the terminal based on citation tokens. For example, when a user clicks on button 522, the user interface may display logs 524 and highlight input 526 that the AI model provided to the container corresponding to the citation token, allowing the user to audit the actions taken by the AI model.

FIG. 5D illustrates the user interface illustrating a diff in accordance with some aspects of the disclosure. In this case, the change corresponds to the changes in FIG. 5C and illustrates that a diff interface 528 showing a file modified (test_model_visibility.py) and changes 530 made by the AI model. For example, as narrated in summary 512, the AI model removed the XYZ system hints and removed corresponding code from the test.

In some aspects, the PR maintains a human review step in the development workflow, which is important when changes are generated automatically. Requiring approval from a developer or reviewer before merging ensures that code is examined for functional correctness, style, architectural consistency, and potential security or performance issues. This human-in-the-loop model acts as a safeguard against unintended consequences and allows teams to maintain high code quality when using machine learning systems or automation tools to generate or modify code. The structured review process provides transparency, accountability, and an opportunity for collaborative improvement before any changes are integrated into the main codebase.

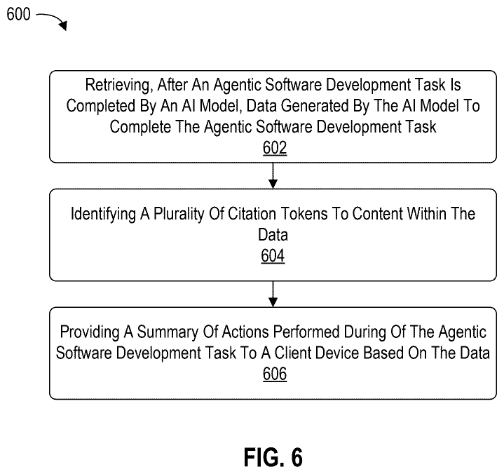

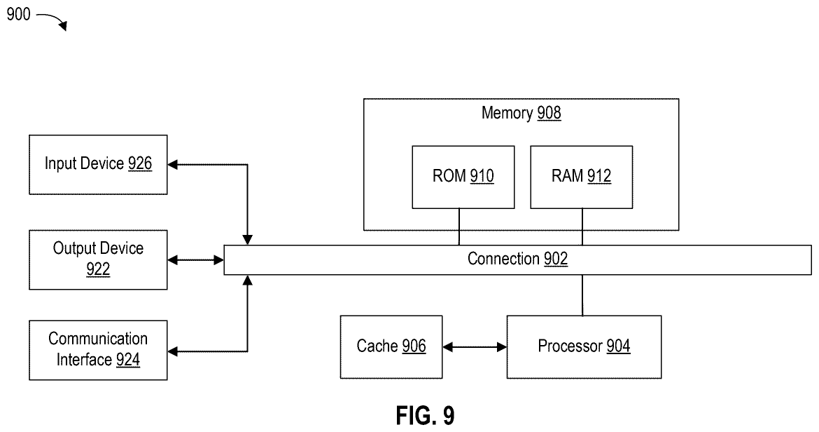

FIG. 6 illustrates a flowchart of a process for generating citation tokens during an automated software development task in accordance with some aspects of the disclosure. Process 600 (or any other described herein) can be performed by a computing device (or apparatus) or a component (e.g., one or more chipsets, a SoC, one or more processors such as one or more CPUs, GPUs, DSPs, NPUs, NSPs, microcontrollers, ASICs, FPGAs, programmable logic devices, discrete gates or transistor logic components, discrete hardware components, etc., an ML system such as a neural network model, any combination thereof, and/or other component or system) of the computing device. The operations of process 600 may be implemented as software components that are executed and run on one or more processors (e.g., CPU, GPU, DSP, NPU or neural engine, SoC, processor 904 of FIG. 9, and/or other processor(s)).

In some aspects, the computing device may facilitate an agentic software development task. For example, the computing system may provide, to a client device, a user interface to allow a user to input, in natural language, the agentic software development task (or software development task).

At block 602, the computing system may retrieve, after an agentic software development task is completed by an AI model, data generated by the AI model to complete the agentic software development task.

At block 604, the computing system may identify a plurality of citation tokens to content within the data. A respective citation token of the plurality of citation tokens includes a reference to events performed by the AI model to complete the agentic software development task. A citation token includes a type of citation that corresponds to an event performed by the AI model. Non-limiting examples of citation tokens include a file citation or a command citation. Other types can reference information with a URL or other address information, use model context protocol (MCP) information, etc.

Citation tokens can be formatted text reference that has a structure that identifies a type and metadata associated with the citation tokens (e.g., line numbers, commands, parameters). For example, a respective citation token comprises a reference to a terminal emulator log when the type corresponds to a command citation. In another example, the respective citation token comprises a line number associated with changes to a file when the respective citation token corresponds to a file citation.

At block 606, the computing system may provide a summary of actions performed during the agentic software development task to a client device based on the data. The summary includes information pertaining to changes generated based on the plurality of citation tokens. For example, as part of block 606, the computing system may determine a type of the respective citation token based on a format of the respective citation token and information associated with a change corresponding to the respective citation token. The summary may include information for rendering interactable components associated with the respective citation token at the client (or the summary can include the interactable components directly, depending on the rendering of the client application).

In some aspects, the block 606 may occur at runtime associated with a client application (e.g., the front end). For example, the client application can receive the data and may display the summary with interactive markup elements. As an example, the client application may include a component including a parsing function that parses the data and generates a view based on data in that view. In one example, the citation tokens can be replaced by an interactive components.

In other aspects, block 606 may occur during extraction from the container. For example, the data is retrieved from a container (e.g., the container is mounted or a service is allowed to execute a command such as docker exec to extract the data) and is parsed for citation tokens. For example, the data may be in a raw text format and may be parsed into JSON while separating out features such as citation tokens into suitable form.

The client device is configured to display the summary of the software development task, and the summary is demarcated based on the plurality of citation tokens. The user may interact with any of components corresponding to the citation tokens (e.g., as shown in FIGS. 5C and 5D) to display detailed information and allow the user to audit the modifications, commands, and other inputs the AI model performed on the code repository in the container. For example, the AI model is configured to generate at least one citation token as part of an event generated during the agentic software development task. As shown in FIGS. 3 and 4, the AI model is configured to plan concrete tasks to achieve the software development task, and each event (or task) generated by AI model can include a citation token. For example, the citation tokens correspond to changes and events performed by the AI model that are normally implemented by a developer. The citation tokens allow the computing device to perform the agentic software development task on a code repository and a branch of the code repository.

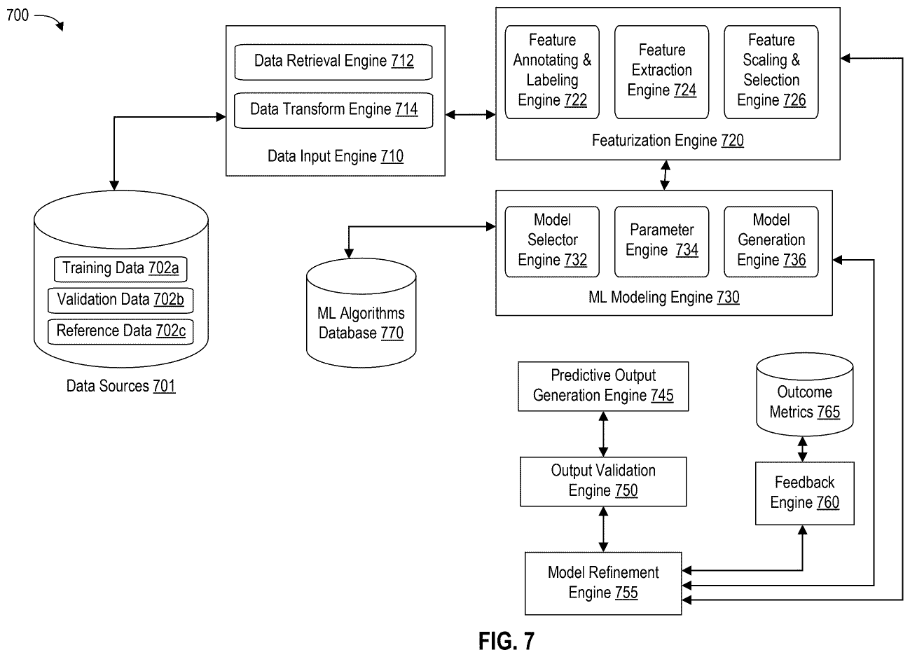

FIG. 7 is a block diagram illustrating an example machine learning platform for implementing various aspects of this disclosure in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 700 may include data input engine 710 that can further include data retrieval engine 712 and data transform engine 714. Data retrieval engine 712 may be configured to access, interpret, request, or receive data, which may be adjusted, reformatted, or changed (e.g., to be interpretable by another engine, such as data input engine 710). For example, data retrieval engine 712 may request data from a remote source using an API. Data input engine 710 may be configured to access, interpret, request, format, re-format, or receive input data from data sources(s) 701. For example, data input engine 710 may be configured to use data transform engine 714 to execute a re-configuration or other change to data, such as a data dimension reduction. In some aspects, data sources(s) 701 may be associated with a single entity (e.g., organization) or with multiple entities. Data sources(s) 701 may include one or more of training data 702a (e.g., input data to feed a machine learning model as part of one or more training processes), validation data 702b (e.g., data against which at least one processor may compare model output with, such as to determine model output quality), and/or reference data 702c. In some aspects, data input engine 710 can be implemented using at least one computing device. For example, data from data sources(s) 701 can be obtained through one or more I/O devices and/or network interfaces. Further, the data may be stored (e.g., during execution of one or more operations) in a suitable storage or system memory. Data input engine 710 may also be configured to interact with a data storage, which may be implemented on a computing device that stores data in storage or system memory.

System 700 may include featurization engine 720. Featurization engine 720 may include feature annotating & labeling engine 722 (e.g., configured to annotate or label features from a model or data, which may be extracted by feature extraction engine 724), feature extraction engine 724 (e.g., configured to extract one or more features from a model or data), and/or feature scaling & selection engine 726 Feature scaling & selection engine 726 may be configured to determine, select, limit, constrain, concatenate, or define features (e.g., AI features) for use with AI models.

System 700 may also include ML modeling engine 730, which may be configured to execute one or more operations on a machine learning model (e.g., model training, model re-configuration, model validation, model testing), such as those described in the processes described herein. For example, ML modeling engine 730 may execute an operation to train a machine learning model, such as adding, removing, or modifying a model parameter. Training of a machine learning model may be supervised, semi-supervised, or unsupervised. In some aspects, training of a machine learning model may include multiple epochs, or passes of data (e.g., training data 702a) through a machine learning model process (e.g., a training process). In some aspects, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed aspects in any way, a machine learning model may include millions, billions, or even trillions of model parameters. ML modeling engine 730 may include model selector engine 732 (e.g., configured to select a model from among a plurality of models, such as based on input data), parameter engine 734 (e.g., configured to add, remove, and/or change one or more parameters of a model), and/or model generation engine 736 (e.g., configured to generate one or more machine learning models, such as according to model input data, model output data, comparison data, and/or validation data).

In some aspects, model selector engine 732 may be configured to receive input and/or transmit output to ML algorithms database 770. Similarly, featurization engine 720 can utilize storage or system memory for storing data and can utilize one or more I/O devices or network interfaces for transmitting or receiving data. ML algorithms database 770 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a diffusion model, a diffusion-transformer model, an encoder such as BERT (Bidirectional Encoder Representations from Transformers) or LXMERT (Learning Cross-Modality Encoder Representations from Transformers), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein. Some of the ML algorithms in ML algorithms database 770 can be considered generative response engines. Generative response engines are those models are commonly referred to as Generative AI, and that can receive an input prompt and generate additional content based on the prompt. GPTs, diffusion models, and diffusion-transformer models are some non-limiting examples of generative response engines. Some specific examples of generative response engines that can be stored in the ML algorithms database 770 include versions DALL·E, CHAT GPT, and SORA, all provided by OPEN AI.

System 700 can further include predictive output generation engine 745 and output validation engine 750 (e.g., configured to apply validation data to machine learning model output). Predictive output generation engine 745 can analyze the input and identify relevant patterns and associations in the data it has learned to generate a sequence of words that predictive output generation engine 745 predicts is the most likely continuation of the input using one or more models from the ML algorithms database 770, aiming to provide a coherent and contextually relevant answer. Predictive output generation engine 745 generates responses by sampling from the probability distribution of possible words and sequences, guided by the patterns observed during its training. In some aspects, predictive output generation engine 745 can generate multiple possible responses before presenting the final one. Predictive output generation engine 745 can generate multiple responses based on the input, and these responses are variations that predictive output generation engine 745 considers potentially relevant and coherent. Output validation engine 750 can evaluate these generated responses based on certain criteria. These criteria can include relevance to the prompt, coherence, fluency, and sometimes adherence to specific guidelines or rules, depending on the application. Based on this evaluation, output validation engine 750 selects the most appropriate response. This selection is typically the one that scores highest on the set criteria, balancing factors like relevance, informativeness, and coherence.

System 700 can further include feedback engine 760 (e.g., configured to apply feedback from a user and/or machine to a model) and model refinement engine 755 (e.g., configured to update or re-configure a model). In some aspects, feedback engine 760 may receive input and/or transmit output (e.g., output from a trained, partially trained, or untrained model) to outcome metrics database 765. Outcome metrics database 765 may be configured to store output from one or more models and may also be configured to associate output with one or more models. In some aspects, outcome metrics database 765, or other device (e.g., model refinement engine 755 or feedback engine 760), may be configured to correlate output, detect trends in output data, and/or infer a change to input or model parameters to cause a particular model output or type of model output. In some aspects, model refinement engine 755 may receive output from predictive output generation engine 745 or output validation engine 750. In some aspects, model refinement engine 755 may transmit the received output to featurization engine 720 or ML modeling engine 730 in one or more iterative cycles.

The engines of system 700 may be packaged functional hardware units designed for use with other components or a part of a program that performs a particular function (e.g., of related functions). Any or each of these modules may be implemented using a computing device. In some aspects, the functionality of system 700 may be split across multiple computing devices to allow for distributed processing of the data, which may improve output speed and reduce computational load on individual devices. In some aspects, system 700 may use load-balancing to maintain stable resource load (e.g., processing load, memory load, or bandwidth load) across multiple computing devices and to reduce the risk of a computing device or connection becoming overloaded. In these or other aspects, the different components may communicate over one or more I/O devices and/or network interfaces.

System 700 can be related to different domains or fields of use. Descriptions of aspects related to specific domains, such as natural language processing or language modeling, is not intended to limit the disclosed aspects to those specific domains, and aspects consistent with the present disclosure can apply to any domain that utilizes predictive modeling based on available data.

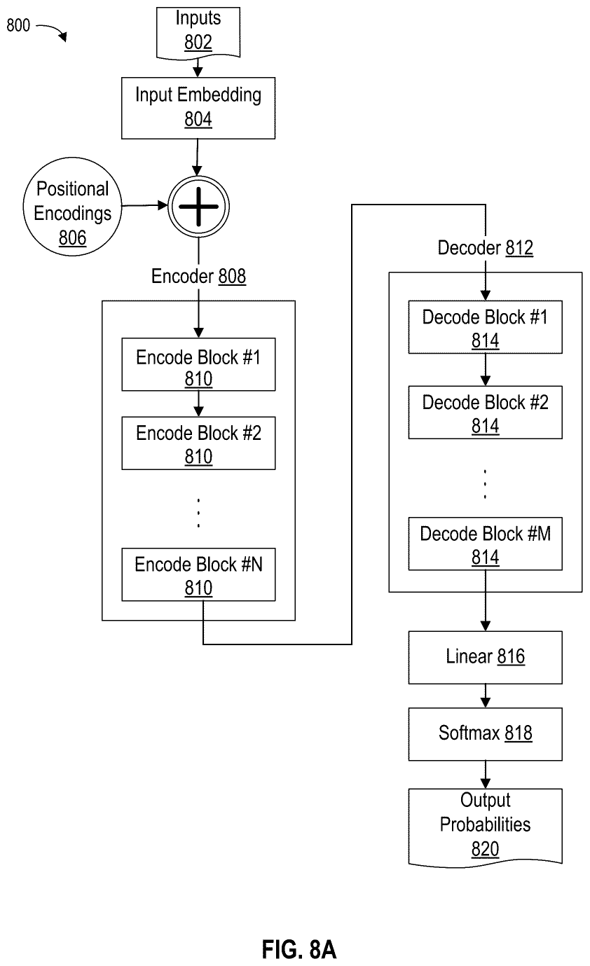

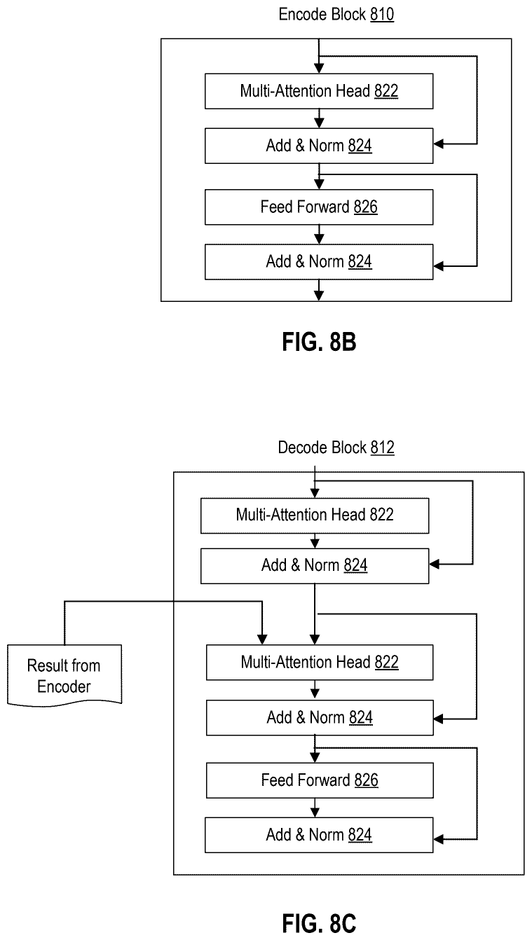

FIG. 8A, FIG. 8B, and FIG. 8C illustrates an example transformer architecture in accordance with some aspects of the present technology. Examples of ML models that use a transformer neural network (e.g., transformer architecture 800) can include, e.g., generative pretrained transformer (GPT) models and Bidirectional Encoder Representations from Transformer (BERT) models. The transformer architecture 800, which is illustrated in FIG. 8A, FIG. 8B, and FIG. 8C, includes inputs 802, input embedding block 804, positional encodings 806, encoder 808 including encode blocks 810, decoder 812 including decode blocks 814, linear block 816, softmax block 818, and output probabilities 820.

Input embedding block 804 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 804 can be learned embeddings to convert the input tokens and output tokens to vectors of dimension that have the same dimension as the positional encodings, for example.

Positional encodings 806 provide information about the relative or absolute position of the tokens in the sequence. According to certain non-limiting examples, positional encodings 806 can be provided by adding positional encodings to the input embeddings at the inputs to the encoder 808 and decoder 812. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 808 can use stacked self-attention and point-wise, fully connected layers. Encoder 808 can be a stack of N identical layers (e.g., N=6), and each layer can be an encode block, as illustrated by encode block 810 shown in FIG. 8B. Each encode block 810 has two sub-layers: (i) a first sub-layer has a multi-head attention block 822 and (ii) a second sub-layer has a feed forward block 826, which can be a position-wise fully connected feed-forward network. The feed forward block 826 can use a rectified linear unit (ReLU).

Encoder 808 uses a residual connection around each of the two sub-layers, followed by an add & norm block 824, which performs normalization. For example, the output of each sub-layer can be LayerNorm(x+Sublayer(x)). To facilitate these residual connections, all sub-layers in the model, as well as the embedding layers, produce output data having a same dimension.

Similar to encoder 808, decoder 812 uses stacked self-attention and point-wise, fully connected layers. Decoder 812 can also be a stack of M identical layers (e.g., M=6), and each layer can be a decode block, as illustrated by decoder 812 shown in FIG. 8B. In addition to the two sub-layers (i.e., the sublayer with multi-head attention block 822 and the sub-layer with feed forward block 826) found in encode block 810, decode block 814 can include a third sub-layer, which performs multi-head attention over the output of the encoder stack. Similar to encoder 808, decoder 812 uses residual connections around each of the sub-layers, followed by layer normalization. Additionally, the sub-layer with multi-head attention block 822 can be modified in the decoder stack to prevent positions from attending to subsequent positions. This masking, combined with the fact that the output embeddings are offset by one position, can ensure that the predictions for position i can depend only on the known output data at positions less than i.

Linear block 816 can be a learned linear transformation. For example, when transformer architecture 800 is being used to translate from a first language into a second language, linear block 816 can project the output from the last decode softmax block 818 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

Softmax block 818 then turns the scores from linear block 816 into output probabilities 820 (which add up to 1.0). In each position, the index provides for the word with the highest probability, and then maps that index to the corresponding word in the vocabulary. Those words then form the output sequence of transformer architecture 800. The softmax operation is applied to the output from linear block 816 to convert the raw numbers into output probabilities 820 (e.g., token probabilities).

FIG. 9 shows an example of computing system 900, which can be, for example, any computing device making up any engine illustrated in FIG. 1 or any component thereof.

In some aspects, computing system 900 is a single device, or a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

In some aspects, computing system 900 may comprise one or more computing resources provisioned from a “cloud computing” provider, For example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 900 includes at least one processing unit (CPU or processor) 904 and connection 902 that couples various system components including system memory 908, such as read-only memory (ROM) 910 and random access memory (RAM) 912 to processor 904. Memory 908 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Memory 908 can include software services, servers, logic, etc., that when the code that defines such software is executed by the processor 904, it causes the system to perform a function. In some aspects, a hardware service that performs a particular function can include the software component stored in a computer-readable medium in connection with the necessary hardware components, such as processor 904, connection 902, output device 922, etc., to carry out the function.

Computing system 900 can include a cache of high-speed memory 906 connected directly with, in close proximity to, or integrated as part of processor 904.

Connection 902 can be a physical connection via a bus, or a direct connection into processor 904, such as in a chipset architecture. Connection 902 can also be a virtual connection, networked connection, or logical connection.

Processor 904 can include any general purpose processor and a hardware service or software service stored in memory 908, configured to control processor 904 as well as a special-purpose processor where software instructions are incorporated into the actual processor design. Processor 904 may essentially be a completely self-contained computing system, containing multiple cores or processors, a bus, memory controller, cache, etc. A multi-core processor may be symmetric or asymmetric. Processor 904 can be physical or virtual.

To enable user interaction, computing system 900 includes an input device 926, which can represent any number of input mechanisms, such as a microphone for speech, a touch-sensitive screen for gesture or graphical input, keyboard, mouse, motion input, speech, etc. Computing system 900 can also include output device 922, which can be one or more of a number of output mechanisms known to those of skill in the art. In some instances, multimodal systems can enable a user to provide multiple types of input/output to communicate with computing system 900. Computing system 900 can include communication interface 924, which can generally govern and manage the user input and system output. There is no restriction on operating on any particular hardware arrangement, and therefore the basic features here may easily be substituted for improved hardware or firmware arrangements as they are developed.

In some aspects, computing system 900 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

The present technology includes computer-readable storage mediums for storing instructions, and systems for executing any one of the methods embodied in the instructions addressed in the aspects of the present technology presented below:

Aspect 1. A method of automating software development, comprising: retrieving, after an agentic software development task is completed by an AI model, data generated by the AI model to complete the agentic software development task; identifying a plurality of citation tokens to content within the data, wherein a respective citation token of the plurality of citation tokens includes a reference to events performed by the AI model to complete the agentic software development task; and providing a summary of actions performed during of the agentic software development task to a client device based on the data, wherein the summary includes information pertaining to changes generated based on the plurality of citation tokens.

Aspect 2. The method of Aspect 1, wherein a citation token includes a type of citation that corresponds to an event performed by the AI model.

Aspect 3. The method of Aspect 2, wherein the type of citation token includes one of a file citation or a command citation.

Aspect 4. The method of any of Aspects 1 to 3, further comprising: determining a type of the respective citation token based on a format of the respective citation token and information associated with a change corresponding to the respective citation token.

Aspect 5. The method of Aspect 4, wherein the respective citation token comprises a reference to a terminal emulator log when the type corresponds to a command citation.

Aspect 6. The method of any of Aspects 4 to 5, wherein the respective citation token comprises a line number associated with changes to a file when the respective citation token corresponds to a file citation.

Aspect 7. The method of any of Aspects 1 to 6, wherein the summary includes interactable components associated with the respective citation token.

Aspect 8. The method of any of Aspects 1 to 7, further comprising: providing, to the client device, the summary demarcated based on the plurality of citation tokens for displaying the summary at the client device and the changes corresponding to the plurality of citation tokens at the client device.

Aspect 9. The method of any of Aspects 1 to 8, wherein the AI model is configured to generate at least one citation token as part of an event generated during the agentic software development task.

Aspect 10. The method of any of Aspects 1 to 9, wherein the agentic software development task is performed on a code repository and a branch of the code repository.

Aspect 11. A computing device, comprising: at least one memory; and at least one processor coupled to the at least one memory and configured to: retrieve, after an agentic software development task is completed by an AI model, data generated by the AI model to complete the agentic software development task; identify a plurality of citation tokens to content within the data, wherein a respective citation token of the plurality of citation tokens includes a reference to events performed by the AI model to complete the agentic software development task; and provide a summary of actions performed during of the agentic software development task to a client device based on the data, wherein the summary includes information pertaining to changes generated based on the plurality of citation tokens.

Aspect 12. The computing device of Aspect 11, wherein a citation token includes a type of citation that corresponds to an event performed by the AI model.

Aspect 13. The computing device of Aspect 12, wherein the type of citation token includes one of a file citation or a command citation.

Aspect 14. The computing device of any of Aspects 11 to 13, wherein the at least one processor is configured to: determine a type of the respective citation token based on a format of the respective citation token and information associated with a change corresponding to the respective citation token.

Aspect 15. The computing device of Aspect 14, wherein the respective citation token comprises a reference to a terminal emulator log when the type corresponds to a command citation.

Aspect 16. The computing device of any of Aspects 14 to 15, wherein the respective citation token comprises a line number associated with changes to a file when the respective citation token corresponds to a file citation.

Aspect 17. The computing device of any of Aspects 11 to 16, wherein the summary includes interactable components associated with the respective citation token.

Aspect 18. The computing device of any of Aspects 11 to 17, wherein the at least one processor is configured to: provide, to the client device, the summary demarcated based on the plurality of citation tokens for displaying the summary at the client device and the changes corresponding to the plurality of citation tokens at the client device.

Aspect 19. The computing device of any of Aspects 11 to 18, wherein the AI model is configured to generate at least one citation token as part of an event generated during the agentic software development task.

Aspect 20. The computing device of any of Aspects 11 to 19, wherein the agentic software development task is performed on a code repository and a branch of the code repository.

Aspect 21. A non-transitory computer-readable medium having stored thereon instructions that, when executed by at least one processor, cause the at least one processor to perform operations according to any of Aspects 1 to 10.

Aspect 22. An apparatus for performing a function, comprising one or more means for performing operations according to any of Aspects 1 to 10.

What is claimed is:

1. A method of automating software development, comprising:
retrieving, after an agentic software development task is completed by an AI model, data generated by the AI model to complete the agentic software development task;
identifying a plurality of citation tokens to content within the data, wherein a respective citation token of the plurality of citation tokens includes a reference to events performed by the AI model to complete the agentic software development task; and
providing a summary of actions performed during of the agentic software development task to a client device based on the data, wherein the summary includes information pertaining to changes generated based on the plurality of citation tokens.

2. The method of claim 1, wherein a citation token includes a type of citation that corresponds to an event performed by the AI model.

3. The method of claim 2, wherein the type of citation token includes one of a file citation or a command citation.

4. The method of claim 1, further comprising:
determining a type of the respective citation token based on a format of the respective citation token and information associated with a change corresponding to the respective citation token.

5. The method of claim 4, wherein the respective citation token comprises a reference to a terminal emulator log when the type corresponds to a command citation.

6. The method of claim 4, wherein the respective citation token comprises a line number associated with changes to a file when the respective citation token corresponds to a file citation.

7. The method of claim 1, wherein the summary includes interactable components associated with the respective citation token.

8. The method of claim 1, wherein the summary is demarcated based on the plurality of citation tokens for displaying the summary at the client device and the changes corresponding to the plurality of citation tokens at the client device.

9. The method of claim 1, wherein the AI model is configured to generate at least one citation token as part of an event generated during the agentic software development task.

10. The method of claim 1, wherein the agentic software development task is performed on a code repository and a branch of the code repository.

11. A computing device, comprising:
at least one memory; and
at least one processor coupled to the at least one memory and configured to:
retrieve, after an agentic software development task is completed by an AI model, data generated by the AI model to complete the agentic software development task;
identify a plurality of citation tokens to content within the data, wherein a respective citation token of the plurality of citation tokens includes a reference to events performed by the AI model to complete the agentic software development task; and
provide a summary of actions performed during of the agentic software development task to a client device based on the data, wherein the summary includes information pertaining to changes generated based on the plurality of citation tokens.

12. The computing device of claim 11, wherein a citation token includes a type of citation that corresponds to an event performed by the AI model.

13. The computing device of claim 12, wherein the type of citation token includes one of a file citation or a command citation.

14. The computing device of claim 11, wherein the at least one processor is configured to:
determine a type of the respective citation token based on a format of the respective citation token and information associated with a change corresponding to the respective citation token.

15. The computing device of claim 14, wherein the respective citation token comprises a reference to a terminal emulator log when the type corresponds to a command citation.

16. The computing device of claim 14, wherein the respective citation token comprises a line number associated with changes to a file when the respective citation token corresponds to a file citation.

17. The computing device of claim 11, wherein the summary includes interactable components associated with the respective citation token.

18. The computing device of claim 11, wherein the summary demarcated based on the plurality of citation tokens for displaying the summary at the client device and the changes corresponding to the plurality of citation tokens at the client device.

19. The computing device of claim 11, wherein the AI model is configured to generate at least one citation token as part of an event generated during the agentic software development task.

20. The computing device of claim 11, wherein the agentic software development task is performed on a code repository and a branch of the code repository.
